(19) United States
(12) Patent Application Publication
(10) Pub. No.: US 2015/0338880 A1
(43) Pub. Date: Nov. 26, 2015

(54) BAND AND ELECTRONIC DEVICE

(71) Applicant: Kabushiki Kaisha Toshiba, Tokyo (JP)

(72) Inventor: Yuki Sato, Ome Tokyo (JP)

(21) Appl. No.: 14/664,670

(22) Filed: Mar. 20, 2015

(30) Foreign Application Priority Data
May 26, 2014 (JP) 2014-108248

(51) Int. Cl. G06F 1/16

(52) U.S. Cl. CPC G06F 1/163

(57) ABSTRACT

According to one embodiment, a band includes a band body, a sensor, and a conducting wire. The band body is worn around a part of a living body, and holds a case equipped with an electronic module. The sensor is provided on the band body and detects vital signs from the living body. The conducting wire electrically connects the sensor to the electronic module.

### CROSS-REFERENCE TO RELATED APPLICATIONS

This application is based upon and claims the benefit of priority from Japanese Patent Application No. 2014-108248, filed May 26, 2014, the entire contents of which are incorporated herein by reference.

### FIELD

Embodiments described herein relate generally to a band and an electronic device.

### BACKGROUND

An electronic device worn on a part of the living body, such as wrist, by means of a band and having sensors for detecting vital signs, such as pulse and body temperature, has been developed.

It is required to detect vital signs much more accurately by the sensors.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a view schematically illustrating an example of an electronic device according to a first embodiment;

FIG. 2 is a view schematically illustrating an exemplified connecting mechanism of the electronic device for connecting the band body of the band and the base of the sensor;

FIG. 3 is a view schematically illustrating an exemplified wearing mechanism for the band of the electronic device;

FIG. 4 is a view illustrating an exemplified section along the line IV-IV in FIG. 1;

FIG. 5 is a view schematically illustrating an example of tubes and conducting wires, extending through in the band body of the band;

FIG. 6 is a view schematically illustrating an example of the structure of a case of electronic device, a first holder and a second holder;

FIG. 7 is a view schematically illustrating exemplified first terminals and exemplified second terminals as a means for electrically connecting the case and the sensor on the band;

FIG. 8 is a view schematically illustrating another exemplified first terminals and another exemplified second terminals;

FIG. 9 is a view schematically illustrating an exemplified method of charging a battery;

FIG. 10 is a view schematically illustrating an example of an electronic device of a second embodiment;

FIG. 11 is a view schematically illustrating an example of the structure of the case, a first holder and a second holder of the second embodiment;

FIG. 12 is a view schematically illustrating a condition in which a living body wears the electronic device of the second embodiment;

FIG. 13 is a view schematically illustrating another condition in which the living body wears the electronic device of the second embodiment;

FIG. 14 is a view for explaining operational example of the electronic device of the second embodiment;

FIG. 15 is a view for explaining operational example of the electronic device of the second embodiment;

FIG. 16 is a view for explaining a modified example in which an electronic module is arranged on the back surface of the case; and

FIG. 17 is a view for explaining another modified example in which the band is equipped with a plurality of sensors.

### DETAILED DESCRIPTION

Various embodiments will be described hereinafter with reference to the accompanying drawings. For the sake of easiness in explanation there may be a case where some elements are schematically illustrated in the drawings without consideration given to the size or shape. Furthermore, there may be cases where identical or similar elements will be given the same reference number and the redundant explanation for them will be prevented.

In general, according to one embodiment, a band includes a band body, a sensor, and a conducting wire. The band body is worn around a part of a living body, and holds a case equipped with an electronic module. The sensor is provided on the band body and detects vital signs from the living body. The conducting wire electrically connects the sensor to the electronic module.

### First Embodiment

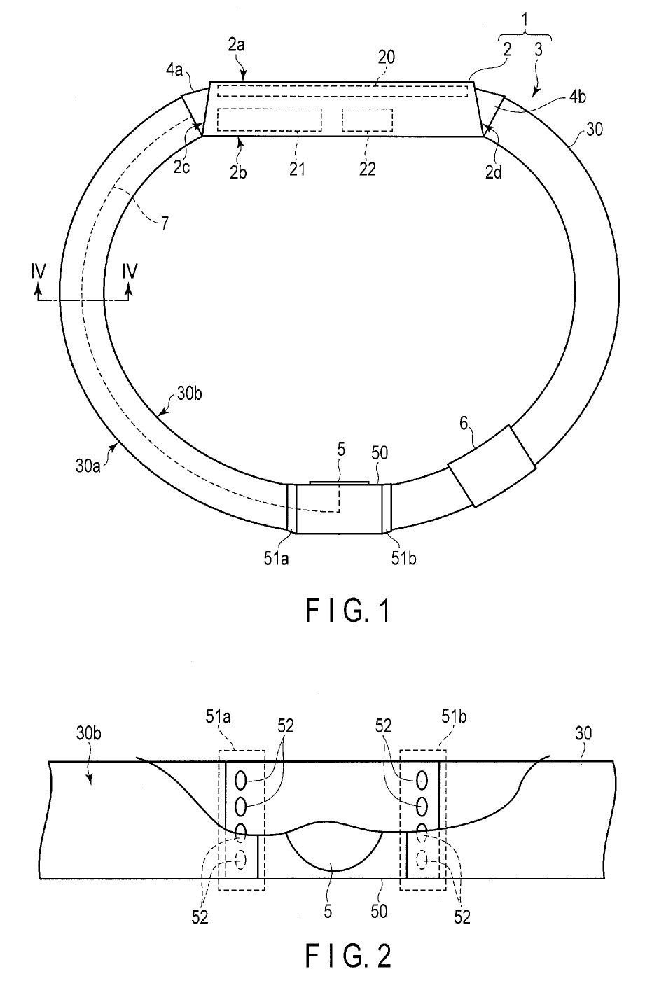

FIG. 1 is a view schematically illustrating an example of an electronic device of the first embodiment. The illustrated electronic device 1, includes a case 2 and a band 3. The electronic device 1 is put on a human body just like a watch by wearing the band 3 around a wrist of the human body (or passing the wrist through the band), for instance. It should be noted that the electronic device 1 can be put on an arm, a leg, or a finger other than a wrist or, alternatively, it can be put on an animal other than a human being.

The case 2 has a first surface 2a (a front surface), a second surface 2b (a back surface), and a circumferential surface connecting the first surface 2a and the second surface 2b. The case 2 is formed of material having rigidity (a rigid body), such as plastic, metal, or alloy.

The case 2 is equipped with a display 20, a controller 21, which includes a processor and memories, and a battery 22, which supplies electrical power to the display 20, the controller 21, and so forth. The display 20 has a display panel, which displays various images on a screen exposed on the first surface 2a, and a touchpanel, which detects operations performed by a user using a stylus or a finger. A liquid crystal device or an organic EL device may be used as a display device of the display panel, for instance. A capacitive mode or a resistive film mode may be used as a detecting mode of the touchpanel, for instance. The display 20 and the controller 21 are instances of the electronic modules.

The band 3 includes a band body 30, a first holder 4a, a second holder 4b, a sensor 5, and a wearing mechanism 6 (a buckle). For instance, the band body 30 is formed of resin material having flexibility and elasticity, such as natural rubber or synthetic rubber, including polyurethane rubber, and is shaped into a band. The band body 30 has an outer circumferential surface 30a and an inner circumferential surface 30b. The inner circumferential surface 30b is a surface facing a part of living body when the band 3 is worn around the living body. The outer circumferential surface 30a is a surface opposite the inner circumferential surface 30b.

The first holder 4a holds the first end portion 2c of the case 2. The second holder 4b holds the second end portion 2d of the case 2 opposite the first end portion 2c.

The sensor 5 detects vital signs of the living body from, for instance, a wrist, around which the band 3 is worn. For instance, the vital signs are measured values indicative of biological information (so called vital signs), such as a pulse rate, a heart rate, a body temperature, a blood pressure, etc. Furthermore, the vital signs may include measured values indicative of biological information, such as a blood oxygen saturation degree, a salt content of sweat, a water content of skin, an oil content of skin, a resilience of skin, etc. It is possible to determine the risk of heatstroke based on the amount of salt contained in sweat. It is also possible to determine a skin age by detecting from the skin its water content, its oil content, and its resilience.

The sensor 5 and the controller 21 are connected with each other by the conducting wires 7 (cables, a harness) passing through within the band body 30. The controller 21 performs various processes using the vital signs indicated by the signals supplied from the sensor 5 through the conducting wires 7. For instance, the controller 21 stores the vital signs in a memory, and displays them on the display 20. The controller 21 makes various assessments based on the vital signs, and informs the assessed results using the display 20. It is possible that the controller 21 causes the display 20 to display the date, the time, the temperature, the moisture, the weather, and so forth. The controller 21 causes the display 20 to display Graphical User Interfaces (GUIs), including various icons which can be operated by the touchpanel, and performs a process in accordance with the operation of the individual GUIs. This kind of electrical device is sometimes called as a smart watch.

In the example of FIG. 1, the sensor 5 is attached to the inner circumferential surface 30b side of the base 50. For instance, the base 50 is formed of material having rigidity (a rigid body), such as plastic, metal, or alloy. The base 50 is connected to the band body 30 by connecting mechanisms 51a, 51b.

FIG. 2 is a view exemplarily illustrating in a schematic manner connecting mechanisms 51a, 51b, in which the base 50 and the band body 30 as seen from the inner circumferential surface 30b side are illustrated in a partially cut away state. FIG. 2 illustrates a case where connecting mechanism 51a connects the base 50 to the band body 30 by means of insert molding. Specifically, the base 50 has a line of through holes 52 at one of its ends along with the extent direction of the band body 30. The band body 30 not only covers each of the through holes 52 from both the inner circumferential surface 30b side and the outer circumferential surface 30a side, but also fills the inside of each of the through holes 52. Two constituents of the band body 30 holding the base 50 in between may be or may not be at least partially connected with each other. It should be noted that the constitution of connecting mechanisms 51a, 51b is not limited to what is illustrated in FIG. 2, but various constitutions may be applicable to them.

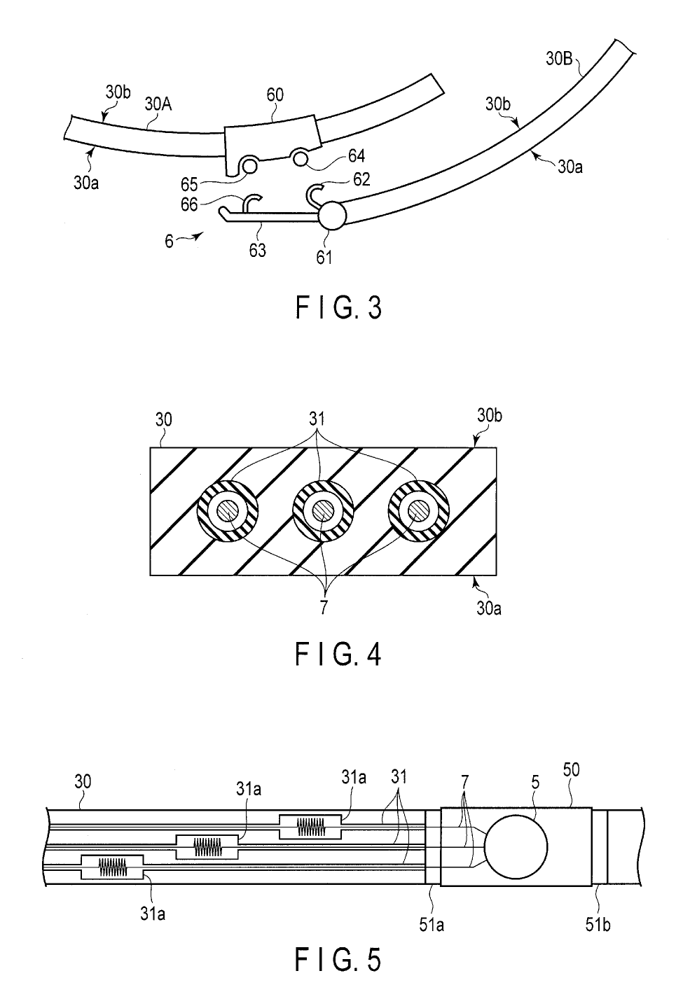

FIG. 3 is a view schematically illustrating one example of the wearing mechanism 6. This figure illustrates a structure that is applicable to a case where one (30A) of the constituents of the band body 30 extending from the side of the first holder 4a to the wearing mechanism 6 is separate from the other (30B) of the constituents of the band body 30 extending from the side of the second holder 4b to the wearing mechanism 6. The wearing mechanism 6 includes a first metal fitting 60 fixed to the band body 30A, and a hinge 61 fixed to the band body 30B, a hook 62 and a second metal fitting 63. The hinge 61 rotatively (pivotally) supports a hook 62 and a second metal fitting 63 so that they may swing with respect to the band body 30B.

The first metal fitting 60 has pins 64, 65 at the outer circumferential surface 30a side of the band body 30A. The second metal fitting 63 has a hook 66 at the inner circumferential surface 30b side of the band body 30B. When the hook 62 is hooked to the pin 64, the first metal fitting 60 and the second metal fitting 63 will be positioned. Under this condition, the hook 66 is hooked to the pin 65. Then, the first metal fitting 60 and the second metal fitting 63 are connected with each other. When the first metal fitting 60 and the second metal fitting 63 are connected with each other while the band body 30A and 30B are put on the living body, then the band 3 or the electronic device 1 can be put on the living body. The size of the band 3 can be adjusted by changing the position where the first metal fitting 60 is attached to the band body 30A.

It should be noted that the constitution of the wearing mechanism 6 is not limited to the example illustrated in FIG. 3. It is possible to adopt as a wearing mechanism a constitution, in which a pin provided at one of the band body constituent 30A and the band body constituent 30B is inserted into a small hole provided at the other of the band body constituent 30A and the band body constituent 30B, or another constitution, in which three metal plates pivotally connected with one another at their respective adjacent ends are folded.

FIG. 4 is a view illustrating an exemplified section along a line IV-IV in FIG. 1. The band body 30 has inside of it hollow tubes 31 extending between the first holder 4a and connecting mechanism 51a. The tubes 31 are made of resin material having elasticity, and their insides provide passages for the conducting wires 7. The conducting wires 7 internally extend through the base 50, connecting mechanism 51a, and the tubes 31 to the first holder 4a. There is a slight space between each of the conducting wires 7, which passes through the inside of the corresponding one of the tubes 31, and the inner wall of the corresponding one of the tubes 31. Therefore, each of the conducting wires 7 can slide on the inner wall of the corresponding one of the tubes 31. It is possible to directly provide passages to the band body 30 without embedding tubes 31.

FIG. 4 illustrates an example in which three tubes 31 are provided in the band body 30, and the conducting wires 7 pass through the respective tubes 31. The conducting wires 7 are classified into three wires, one being a power supply wire for the sensor 5, and the remaining two being output lines from the sensor 5. For instance, the difference between the signals output from the sensor 5 to the two respective output lines corresponds to the vital signs.

FIG. 5 is a view exemplarily illustrating in a schematic manner three tubes 31 and three conducting wires, all extending through inside the band body 30. Each of the tubes 31 has along its length at least one enlarged portion 31a having an elongated internal diameter. Each of the conducting wires 7 is helically wound around at every enlarged portion 31a in the corresponding one of the tubes 31.

When the electronic device 1 is put on the living body, the band body 30 may be elongated from its natural length. The conducting wires 7 are made of metallic material such as copper or copper alloy, and lack elasticity. However, since each of the conducting wires 7 is partly wound around to form at least one helix as illustrated in FIG. 5, the at least one helix will absorb the tension caused by the elongation of the band body 30, so that each of the conducting wires 7 will be prevented from breaking.

When the enlarged portions 31a of the respective tubes 31 overlap each other in the width direction of the band body 30 (the top and bottom direction in FIG. 5), the band body 30 will be thin in wall thickness, and thus the strength of the band body 30 will be degraded. In the example of FIG. 5, however, the enlarged portions 31a are displaced from each other in the extending direction of the band body 30 (the right and left direction in FIG. 5), so that they do not overlap each other in the width direction of the band body 30 (the top and bottom direction in FIG. 5) Therefore, the band body 30 can keep its wall thickness sufficiently thick even at a position where any of the enlarged portions 31a is located, preventing the degradation in the strength of the band body 30.

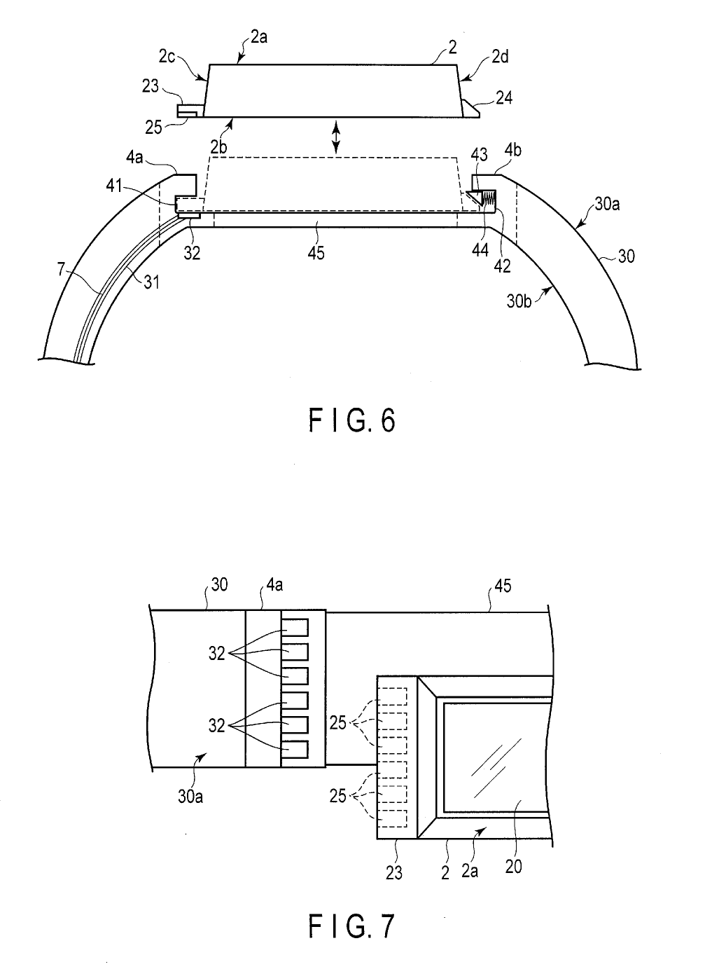

In the present embodiment, the first holder 4a and the second holder 4b detachably hold the case 2 together. FIG. 6 is a view schematically illustrating the exemplified construction of the case 2, that of the first holder 4a and that of the second holder 4b. The case 2 has a first projection 23, which projects outward from the first end portion 2c, and a second projection 24, which projects outward from the second end portion 2d.

The first holder 4a has a groove-shaped first guide 41, into which the first projection 23 fits. The second holder 4b has a groove-shaped second guide 42, into which the second projection 24 fits. The second holder 4b has a movable piece 43 inside the second guide 42, and an elastic body 44 between the movable piece 43 and the inner wall of the second guide 42. The elastic body 44 may be a piece of synthetic rubber, for instance. In the example of FIG. 6, a connecting member 45 is provided between the first holder 4a and the second holder 4b for connecting them.

When the first projection 23 is inserted into the first guide 41, and when the second projection 24 is further inserted into the second guide 42, then the elastic body 44 will contract, and the elastic force that pushes the movable piece 43 out of the second guide 42 will be produced. In this condition, the first projection 23 is regulated in its movement by the inner walls of the first guide 41. The second projection 24 is regulated in its movement by the movable piece 43 which is applied the elastic force and the inner walls of the second guide 42. In this way, the first end portion 2c and the second end portion 2d are respectively held by the first holder 4a and the second holder 4b, thereby a firm installation of the case 2 will be accomplished.

The first holder 4a, the second holder 4b, and the connecting member 45 may be formed as a single unitary body out of material having rigidity (a rigid body), such as plastic, metal, or alloy, or alternatively they may be separately formed and assembled together. Moreover, the first holder 4a, the second holder 4b, and the connecting member 45 may be formed with the band body 30 as a single unitary body. The constitution of the band 3 for holding the case 2 is not limited to what is illustrated in FIG. 6, but various constitutions may be applicable to it. For instance, as another embodiment, the first holder 4a and the second holder 4b may undetachably hold the first end portion 2c and the second end portion 2d, respectively.

In the example of FIG. 6, first terminals 25 electrically connected with the controller 21 are provided on the bottom surface (the surface on the second surface 2b side) of the first projection 23. On the other hand, second terminals 32 electrically connected with the sensor 5 through the conducting wires 7 passing through the tubes 31 are provided on the inner wall of the first guide 41 of the first holder 4a. The first terminals 25 include terminals for supplying electric power to the sensor 5, terminals for inputting signals from the sensor 5, terminals for charging the battery 22, and a terminal for grounding. The second terminals 32 include terminals for supplying electric power to the sensor 5, terminals for outputting signals from the sensor 5, and a terminal for grounding.

FIG. 7 is a view schematically illustrating an exemplified arrangement of the first terminals 25 and the second terminals 32. In the exemplified arrangement illustrated in this figure, the first terminals 25 and the second terminals 32 are rectangular. The first terminals 25 are arranged in a line at regular intervals. The second terminals 32 are also arranged in a line at regular intervals. The first terminals 25 are brought into conduction with the corresponding second terminals 32 when the first holder 4a and the second holder 4b respectively hold the first projection 23 and the second projection 24.

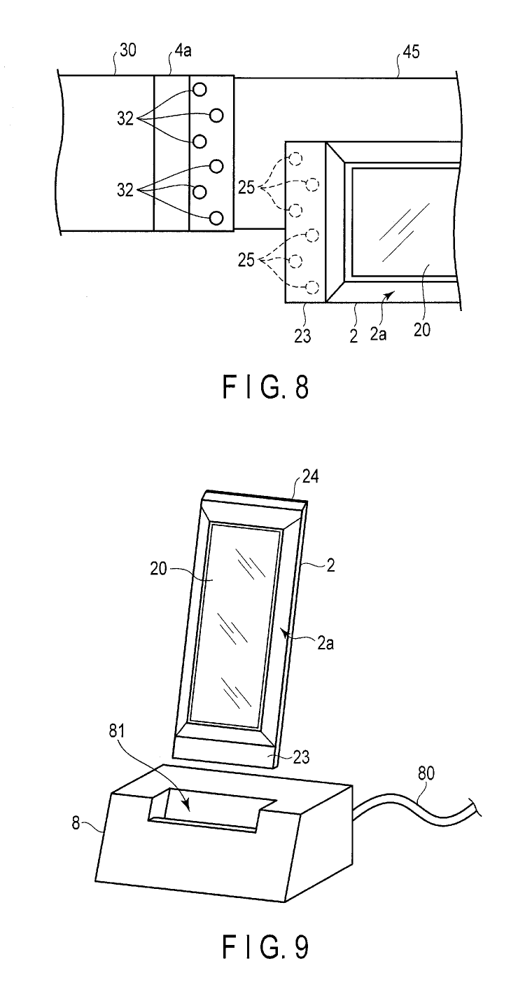

FIG. 8 is a view schematically illustrating another exemplified arrangement of the first terminals 25 and the second terminals 32. In the exemplified arrangement illustrated in this figure, the first terminals 25 and the second terminals 32 are circular. The first terminals 25 are arranged in a zigzag. The second terminals 32 are correspondingly zigzag arranged. The first terminals 25 are brought into conduction with the corresponding second terminals 32 when the first holder 4a and the second holder 4b respectively hold the first projection 23 and the second projection 24.

In each of the exemplified arrangements in FIG. 7 and FIG. 8, it is possible that either the first terminals 25 or the second terminals 32 are made to protrude from the surrounding surface, whereas the rest are made to be depressed from the surrounding surface, and both of the first terminals and the second terminals are fit together. Such an arrangement surely prevents the first terminals 25 and the second terminals 32 from deviating from each other, securing conduction even if impact or vibration is applied to the case 2 or the band 3. Furthermore, even if water adheres to the vicinity of the first terminals 25 or the second terminals 32, it will be difficult for the water to infiltrate into the first terminals 25 or the second terminals 32. Therefore, it will be possible to prevent any short circuit from occurring among those of the first terminals 25 that should not be conducted with one another, or among those of the second terminals 32 that should not be conducted with one another, or between one of the first terminals 25 and a corresponding one of the second terminals 32, both of which should not be conducted with each other.

The battery 22 can be charged when the case 2 is detached from the band 3. For instance, the battery 22 can be charged using a cradle 8 as illustrated in FIG. 9. For instance, the cradle 8 is connected through a cord 80 to a power supply device such as an AC adapter, and has at its top surface an insertion opening 81 for receiving the first projection 23. The insertion opening 81 has inside of it a plurality of terminals for charging the battery 22. When the first projection 23 is inserted into the insertion opening 81, the plurality of terminals are brought into contact with some of the first terminals 25, namely, they are brought into contact with the terminals for charging and the terminal for grounding, and the battery 22 will be charged.

In the present embodiment having been explained above, the sensor 5 is provided to the band body 30, which has both flexibility and elasticity. Should the sensor 5 be on the second surface 2b of the rigid case 2, it will be difficult for the sensor 5 to be in intimate contact with the living body. Therefore, there ought to be the possibility that any vital signs might not be accurately detected. In contrast, in the present embodiment, the sensor 5 will be easily brought into intimate contact with the surface of the living body when the band 3 is put on the living body.

Furthermore, since the case 2 can be detached from the band 3, various good advantages will be obtained. For instance, when the electronic device 1 is used in the situation where the case 2 may easily get wet, or where the battery 22 should be charged, the case 2 can be detached from the band 3 while the band 3 is put on the living body.

In addition, should the structure for attaching or detaching the case 2 to or from the band 3 remain unchanged from model to model, and should various models of the case 2 and of the band 3 different in design or function be sold on a piecemeal basis, the user would be able to freely combine to taste one model of the case 2 and another model of the band 3. It would not be necessary to design and manufacture the band 3 every time a new model of the case 2 should be released, achieving reduction in manufacturing cost.

### Second Embodiment

A second embodiment will be explained below. There are cases where elements identical or similar to those of the first embodiment may be given the same reference numbers as those of the first embodiment, and the redundant explanation will be prevented.

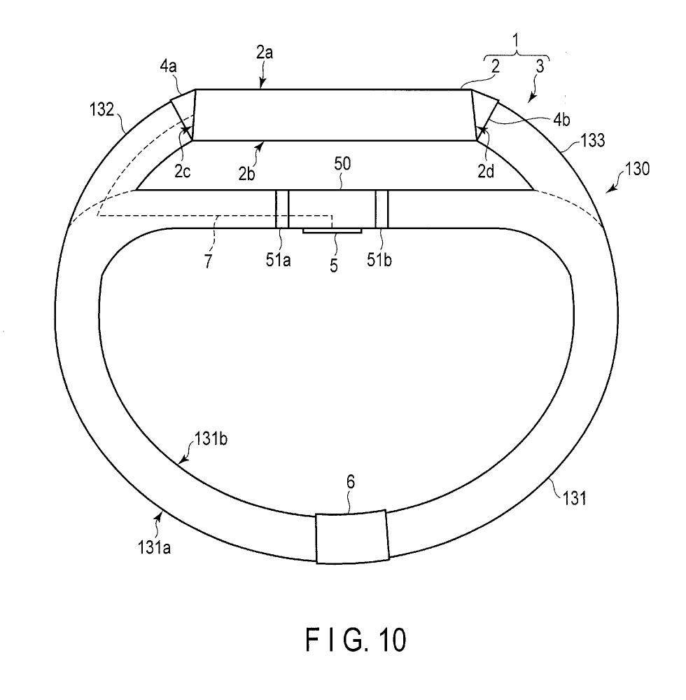

FIG. 10 is a view schematically illustrating an exemplary electronic device 1 in the second embodiment. The illustrated electronic device 1 includes a case 2 and a band 3. The case 2 has the same structure as that of the first embodiment, for instance. The band 3 includes a band body 130, a first holder 4a, a second holder 4b, a sensor 5, and a wearing mechanism 6 (a buckle). The band body 130 includes a first portion 131, a second portion 132, and a third portion 133.

The first portion 131 has an outer circumferential surface 131a and an inner circumferential surface 131b. The inner circumferential surface 131b is a surface facing a part of living body when the band 3 is worn around the living body. The outer circumferential surface 131a is a surface opposite the inner circumferential surface 131b. The second portion 132 and the third portion 133 extend (project) outward from the outer circumferential surface 131a of the first portion 131.

The sensor 5 and the wearing mechanism 6 are provided to the first portion 131. In the example of FIG. 10, the sensor 5 is attached to the inner circumferential surface 131b side of the base 50 connected through connecting mechanisms 51a, 51b to the first portion 131. In the example of FIG. 10, the sensor 5, the base 50, and connecting mechanisms 51a, 51b are located between a position where the second portion 132 is connected with the first portion 131 and a position where the third portion 133 is connected with the first portion 131. For instance, the sensor 5, the wearing mechanism 6, and connecting mechanisms 51a, 51b are the same in structure and function as those of the first embodiment. The sensor 5 and the controller 21 loaded inside the controller 21 are electrically connected with each other by the conducting wires 7.

The conducting wires 7 pass through the respective tubes 31 imbedded in the band body 130 (in the example of FIG. 10, the first portion 131 and the second portion 132) in the same way as the first embodiment, for instance. The tubes 31 individually have at least one enlarged portion 31a such as illustrated in FIG. 5. Each of the conducting wires 7 is helically wound around at every enlarged portion 31a in the corresponding one of the tubes 31.

The first portion 131 is formed of resin material having flexibility and elasticity, such as natural rubber or synthetic rubber, including polyurethane rubber, and is shaped into a band. The second portion 132 and the third portion 133 are made of the same material as the first portion 131, and are formed along with the first portion 131 as a single unitary body. Alternatively, it is also possible as another example that the second portion 132 and the third portion 133 should be made separately from the first portion 131, and be connected to the first portion 131. In such a case, it is possible to form the second portion 132 and the third portion 133 out of material having rigidity (a rigid body), such as plastic, metal, or alloy.

The first holder 4a is provided at the tip of the first portion 132. The second holder 4b is provided at the tip of the second portion 133. The first holder 4a holds the first end portion 2c in such a manner that the first end portion 2c may floatingly move with respect to the outer circumferential surface 131a. The second holder 4b holds the second end portion 2d in such a manner that the second end portion 2d may floatingly move with respect to the outer circumferential surface 131a. The case 2, the first holder 4a, and the second holder 4b may be the same in structure as those of the example illustrated in FIG. 6, for instance. In such a case, the first terminals 25 and the second terminals 32 may be the same in shape and arrangement as those illustrated in FIG. 7 or FIG. 8.

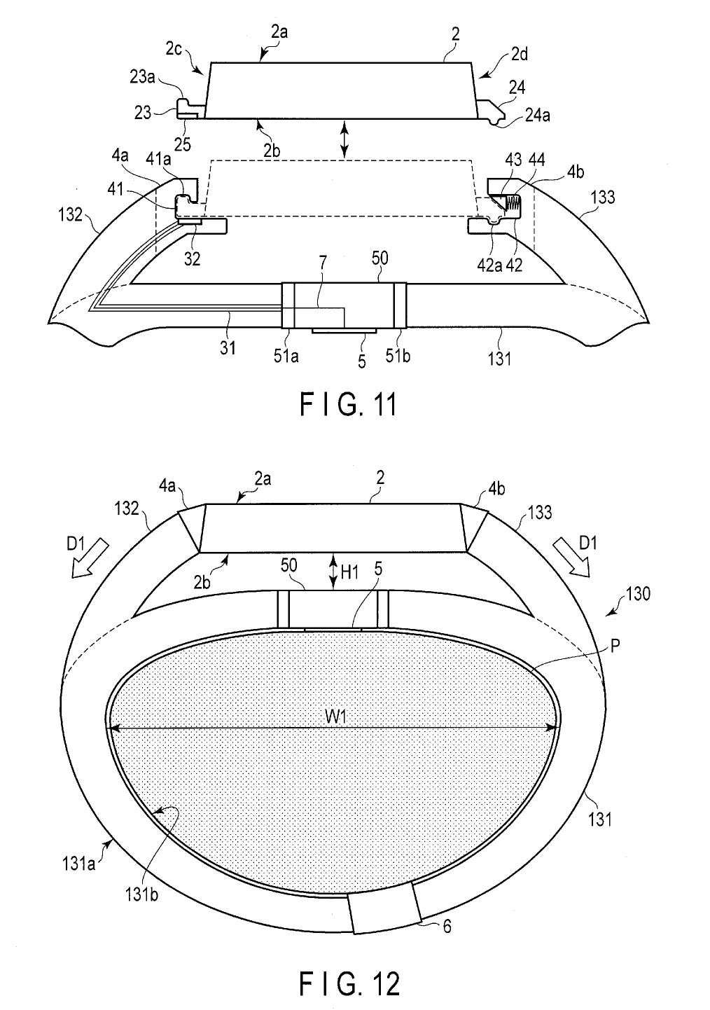

FIG. 11 illustrates another exemplary structure including the case 2, the first holder 4a and the second holder 4b. In the exemplary structure of this figure, the first projection 23 and the second projection 24 individually have a hook shape, and the first guide 41 and the second guide 42 respectively are shaped to receive the first projection 23 and the second projection 24.

Specifically, the first projection 23 has a rib 23a at the first surface 2a side, and the second surface 2b has a rib 24a at the second surface 2b side. The first guide 41 has a groove 41a, into which rib 23a fits, and the second guide 42 has a groove 42a, into which rib 24a fits. When the case 2 is attached to the first holder 4a and the second holder 4b as illustrated by broken lines, rib 23a and rib 24a respectively engage with groove 41a and groove 42a, and thus the case 2 will be securely held. In the example illustrated in FIG. 11, the first guide 41 and the second guide 42 are apart from each other, but they may be connected with each other by a connecting member in the same way as the example illustrated in FIG. 6.

One of the advantages of the present embodiment will be explained below by way of example.

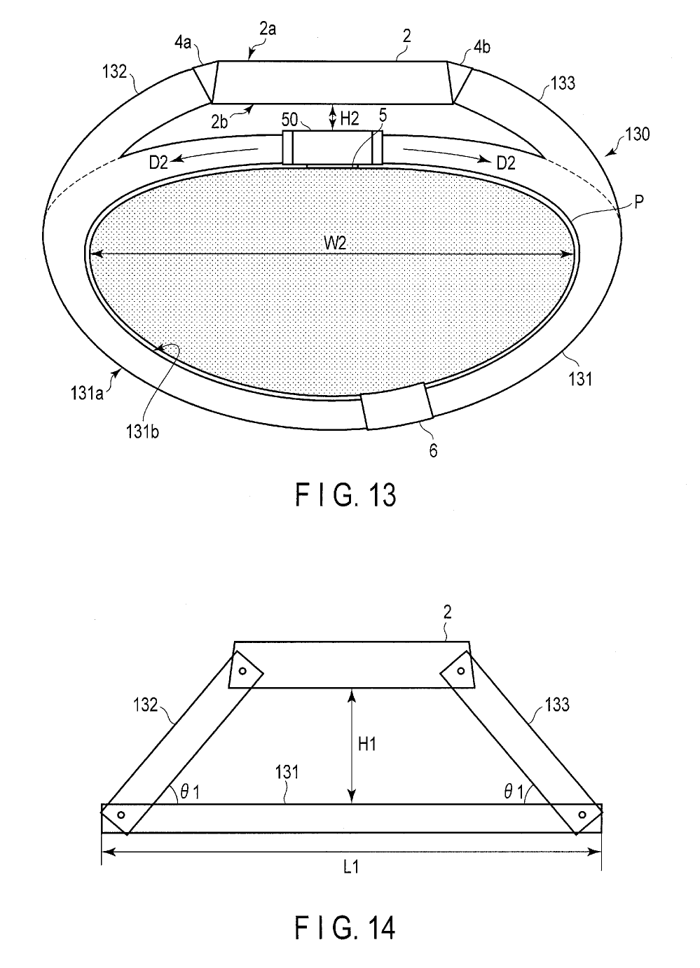

FIG. 12 and FIG. 13 individually are a view schematically illustrating a condition in which a living body P, which is the wrist in this example, wears the electronic device 1. As explained above, the first holder 4a and the second holder 4b respectively hold the first end portion 2c and the second end portion 2d in such a manner that the first end portion 2c and the second end portion 2d may move with respect to the outer circumferential surface 131a. In this way, the case 2 is held between the first holder 4a and the second holder 4b and faces the first portion 131, the first portion 131 will be hardly affected by the case 2, and thus will freely deform (bend or expand) in accordance with the shape of the living body P. The inner circumferential surface 131b will fit the the living body P. Therefore, the sensor 5 will be easily brought into intimate contact with the surface of the living body P, and will be able to accurately detect vital signs of the living body P.

For instance, when the case 2 is at the upper side of the gravitational direction and the living body P is at the lower side of the gravitational direction, then the load of the case 2 is transmitted through both of the second portion 132 and the third portion 133 to the first portion 131 as indicated by two arrows D1 in FIG. 12. Since the load of the case 2 will be dispersed in this way, the living body P will not be locally pressed, resulting in improvement in wearing feeling of the electronic device 1.

In FIG. 12 and FIG. 13, let us suppose that W1 and W2 individually indicate the width of the living body P. In FIG. 12 and FIG. 13, let us suppose that H1 and H2 individually indicate the height from the outer circumferential surface 131a of the first portion 131 (the surface of the base 50 opposite the case 2) to the second surface 2b of the case 2. In the examples illustrated in FIG. 12 and FIG. 13, width W2 is greater than width W1 (W2>W1).

Since the example illustrated in FIG. 13 is larger than the example illustrated in FIG. 12 in width of the living body P, the first portion 131 will expand to pull apart the second portion 132 and the third portion 133 because of the tensile forces acting in two opposite directions as indicated by the arrows D2. Thus, height H2 will be less than height H1 (H2<H1).

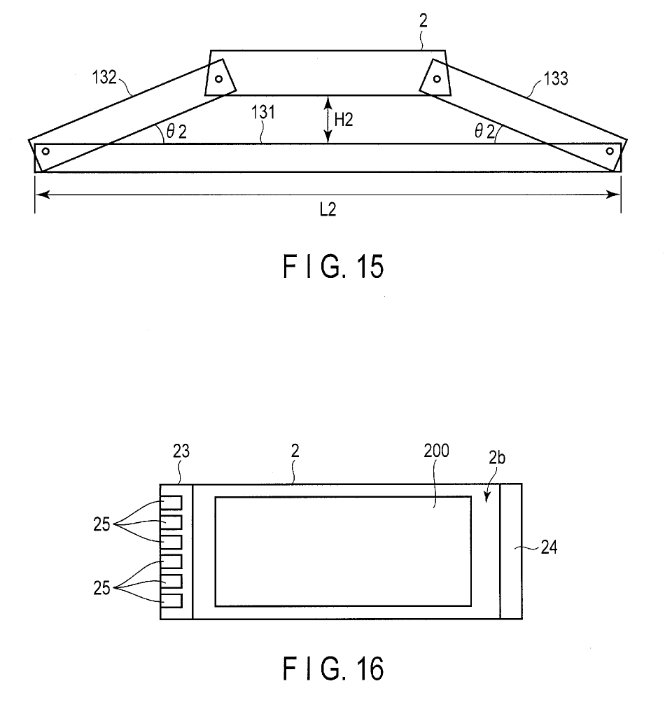

The reason why the distance between the outer circumferential surface 131a and the second surface 2b will change according to the width of the living body P will be explained with reference to the diagram of FIG. 14 and that of FIG. 15. In each of these diagrams, the case 2, the first portion 131, the second portion 132, and the third portion 133 are indicated by a simple link mechanism.

Let us suppose that the case 2, the second portion 132, and the third portion 133, all illustrated in FIG. 14, are the same in length as those illustrated in FIG. 15. What is illustrated in FIG. 14 corresponds to an example in which the width of the living body P is W1, and the length of the first portion 131 extending between the second portion 132 and the third portion 133 is L1. What is illustrated in FIG. 15 corresponds to an example in which the width of the living body P is W2, and the length of the first portion 131 extending between the second portion 132 and the third portion 133 is L2. Since width W2 is greater than width W1, length L2 will be greater than length L1 (L2>L1).

In the example illustrated in FIG. 14, an angle made by the first portion 131 and the second portion 132 and an angle made by the first portion 131 and the third portion 133 are individually denoted as θ1, whereas the corresponding angles in the example illustrated in FIG. 15 are individually denoted as θ2. As geometrically apparent, angle θ2 will be less than angle θ1 due to the difference in length of the first portion 131 (θ2<θ1). Due to this change, height H2 will be less than height H1.

In this way, the force applied to the first portion 131 will be absorbed by the change in height from the outer circumferential surface 131a of the first portion 131 to the second surface 2b of the case 2. Therefore, even if a strong force may be applied to the first portion 131 because of expansion or contraction or bending, the case 2 may be hardly damaged or deformed.

Furthermore, the present embodiment makes it possible to obtain not only the same advantages as the first embodiment, but also much better advantages than the first embodiment.

### Modified Examples

Some modifications will be explained below. It is possible to provide various electronic modules in addition to or in place of the display 20, the controller 21, etc. For instance, it is possible to provide the case 2 with electronic modules, such as press-type buttons, a camera for taking an image, a speaker for producing sound, a communication device for carrying out wired or wireless communication with the outside, etc.

Furthermore, it is possible to arrange an electronic module 200 on the second surface 2b of the case 2 as illustrated in FIG. 16, for instance. The electronic module 200 is, for instance, a solar panel that receives sunlight and generates electricity. The electricity generated by the solar panel can be used to charge the battery 22, for instance. The electronic module 200 is not necessarily confined to the solar panel, but may be buttons, a speaker, a display, a camera, or various terminals.

It is furthermore possible that the first holder 4a and the second holder 4b individually have such a structure that allows them to hold the case 2 that is turned upside down, so that the electronic module 200 may be located on the outside. Moreover, when the first terminals 25 are provided on each of the surfaces of the first projection 23 in such a case, the first terminals 25 arranged on one of the surfaces will surely be brought into electrical contact with the second terminals 32 irrespective of whether the case 2 is attached right side up or upside down.

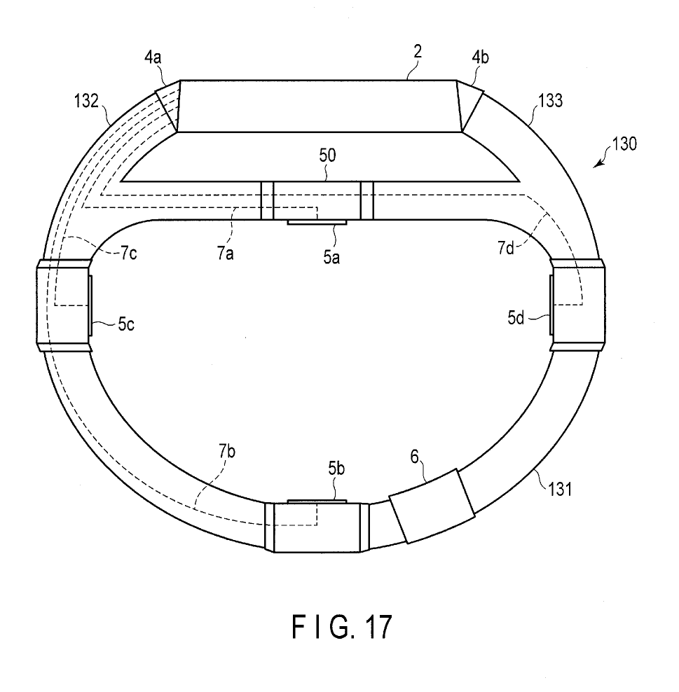

The sensor 5 is not necessarily arranged on the position as illustrated in FIG. 1 or FIG. 10, but may be arranged on any position suitable to obtain vital signs of a detection target. It is also possible to provide a plurality of sensors 5. FIG. 17 illustrates an example in which four sensors 5a, 5b, 5c, 5d are provided to such an electronic device 1 that corresponds to the model illustrated in FIG. 10. In this example, sensor 5a is located between a position where the second portion 132 is connected with the first portion 131 and a position where the third portion 133 is connected with the first portion 131. Sensor 5b is located at a position opposite sensor 5a. Sensor 5c is located between sensor 5b and a position where the second portion 132 is connected with the first portion 131. Sensor 5d is located between sensor 5b and a position where the third portion 133 is connected with the first portion 131. Sensors 5a, 5b, 5c, 5d are electrically connected through the respective conducting wires 7a, 7b, 7c, 7d to the electronic modules, such as the controller 21, etc., inside the case 2.

Sensors 5a, 5b, 5c, 5d may detect either vital signs of different kinds separately allotted them or vital signs of the same kind collectively allotted them. Furthermore, it is possible that the controller 21 may have a function of selecting from sensors 5a, 5b, 5c, 5d a sensor for detecting vital signs of a particular kind. For instance, it is possible that the controller 21 may select a sensor for detecting vital signs of a particular kind in accordance with the instruction input from the operation of the touchpanel by the user, or that a sensor suitable for detecting vital sign of a particular kind is selected based on the detection results of sensors 5a, 5b, 5c, 5d.

The first terminals 25 may conform to a bus standard for USB terminals or HDMI (Registered Trademark) terminals. In such a case, it is possible to form the first projection 23, where the first terminals 25 are arranged, into a shape of a connector conforming to the bus standard and to form the first guide 41 of the first holder 4a into a shape of a port conforming to the bus standard. Then, it becomes possible to directly connect the case 2 to an existing conversion plug or a port of an external device such as a personal computer.

The second terminals 32 may be arranged at the second holder 4b or, alternatively, at both the first holder 4a and the second holder 4b. In these modifications, the first terminals 25 may be suitably located according to the second terminals 32.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A wearable electronic device comprising:
a band configured to be worn around a body part, the band comprising a case with an electronic module, a sensor configured to detect vital signs from the body, and a conducting wire between the sensor and the electronic module.

2. The wearable electronic device of claim 1, wherein the band comprises a passage for the conducting wire, and at least a part of the conducting wire forms a helix in the passage.

3. The wearable electronic device of claim 2, wherein the passage comprises an enlarged portion in internal diameter, and the conducting wire forms a helix in the enlarged portion.

4. The wearable electronic device of claim 1, further comprising:
a holder detachably holding the case; and
a second terminal connected with the sensor through the conducting wire, and with a first terminal upon placement of the case to the holder.

5. The wearable electronic device of claim 1, wherein the band further comprises:
a first portion comprises the sensor, an inner circumferential surface facing the body part, and an outer circumferential surface opposite to the inner circumferential surface;
a second portion extending from the outer circumferential surface to hold a first end portion of the case, and allowing the case to move along the outer circumferential surface; and
a third portion extending from the outer circumferential surface to hold a second end portion of the case, and allowing the case to move along the outer circumferential surface.

6. The wearable electronic device of claim 5,
wherein the second portion further comprises a first holder detachably holding the first end portion, the third portion further comprises a second holder detachably holding the second end portion, and at least one of the second portion and the third portion comprises a connection with the sensor through the conducting wire and the second terminal connected with the first terminal upon the first holder and the second holder respectively holding the first end portion and the second end portion.

7. The wearable electronic device of claim 5, wherein the first portion, the second portion and the third portion are formed of resin material.

8. An electronic device comprising:
a case with an electronic module;
a band comprising the case configured to be worn around a body part;
a sensor on the band configured to detect vital signs from the body; and
a conducting wire connecting between the sensor and the electronic module.

9. The electronic device of claim 8, wherein
a first terminal connected with the electronic module,
a holder detachably holding the case; and
a second terminal connected with the sensor through the conducting wire, and with the first terminal upon placement of the case to the holder.

10. The electronic device of claim 8, wherein the band comprises:
a first portion comprises the sensor, an inner circumferential surface facing the body part, and an outer circumferential surface opposite to the inner circumferential surface;
a second portion extending from the outer circumferential surface to hold a first end portion of the case, and allowing the case to move along the outer circumferential surface; and
a third portion extending from the outer circumferential surface to hold a second end portion of the case, and allowing the case to move along the outer circumferential surface.

11. The electronic device of claim 10, the band further comprising:
the second portion further comprises a first holder detachably holding the first end portion,
the third portion further comprises a second holder detachably holding the second end portion; and
at least one of the second portion and the third portion comprises a connection with the sensor through the conducting wire and the second terminal connected with the first terminal upon the first holder and the second holder respectively holding the first end portion and the second end portion.

12. The electronic device of claim 8, comprising a plurality of sensors, wherein the electronic module is configured to select a sensor for detecting the vital signs from the plurality of sensors.
